(19) United States
(12) Patent Application Publication
(10) Pub. No.: US 2025/0244222 A1
(43) Pub. Date: Jul. 31, 2025

(54) OPTICAL SMOKE DETECTOR WITH LIGHT TRAP, AND LIGHT GUIDING AND BLOCKING MEMBER THEREOF

(71) Applicant: PIXART IMAGING INC., Hsin-Chu County (TW)

(72) Inventors: Guo-Zhen WANG, Hsin-Chu County (TW); Ching-Kun CHEN, Hsin-Chu County (TW)

(21) Appl. No.: 18/425,562

(22) Filed: Jan. 29, 2024

(51) Int. Cl. G01N 15/075; G01N 15/00

(52) U.S. Cl. CPC G01N 15/075; G01N 2015/0046

(57) ABSTRACT

There is provided a smoke detector including a light source, a diffractive optical element, a light sensor, a reflective tilted surface, and a light trap region. The light source projects a shaped light beam on the reflective tilted surface via the diffractive optical element. The reflective tilted surface is arranged right above the light trap region, and used to reflect the shaped light beam to the light trap region. A first light blocking wall is arranged between the light source and the light sensor. A second light blocking wall, higher than the first light blocking wall, is arranged between the light sensor and the light trap region.

### FIELD OF THE DISCLOSURE

This disclosure generally relates to a smoke detector and, more particularly, to an optical smoke detector with a light trap region that reduces the noise interference and a light guiding and blocking member thereof.

### BACKGROUND OF THE DISCLOSURE

The optical smoke detector generally adopts a light emitting diode as a light source to illuminate smoke particles to generate scattered light. The optical smoke detector further adopts a light sensor to detect energy of the scattered light to identify the smoke density or smoke type to accordingly determine whether to give a fire alarm.

However, even in a predetermined light path, not all light beams can be scattered by smoke particles and those light beams not being scattered by the smoke particles can be reflected continuously by inner surfaces in a chamber of the optical smoke detector to generate stray light. Although energy of the stray light can finally disappear due to the energy dissipation during the continuous reflection, a part of the stray light still enters the light sensor to generate noises before the energy thereof is fully dissipated. These noises can cause signals of the detected light energy not all being generated by the scattered light of the smoke particles. Not only the signal measurement error of the optical smoke detector is generated, but also the signal error range caused by a tolerance of the chamber module is not predictable in actual products.

### SUMMARY

Accordingly, it is required to provide a smoke detector that can reduce the interference caused by stray light inside a chamber (or called detection space) of the smoke detector.

The present disclosure provides a smoke detector that is arranged with a light trap structure inside an optical engine thereof to capture light beams not scattered by smoke particles to be received by a light sensor so as to reduce the stray light interference thereby reducing the false alarm.

The present disclosure further provides a smoke detector with a light source and a light sensor being arranged at the same inner surface of a chamber of the smoke detector to reduce a total size thereof.

The present disclosure provides a smoke detector including a light guiding and blocking member, a light source and a light sensor. The light guiding and blocking member includes a first accommodation space, a second accommodation space, a light trap region, a first reflective tilted surface and a second reflective tilted surface, wherein the first reflective tilted space is arranged above the first accommodation space, the second reflective tilted surface is arranged above the light trap region, and the second accommodation space is arranged between the first accommodation space and the light trap region in a first direction. The light source is arranged inside the first accommodation space and configured to project a shaped light beam to the first reflective tilted surface, wherein the first reflective tilted surface is configured to reflect the shaped light beam toward the second reflective tilted surface, and the second reflective tilted surface is configured to reflect a reflected and shaped light beam from the first reflective tilted surface to the light trap region. The light sensor is arranged inside the second accommodation space and configured to receive scattered light generated by the reflected and shaped light beam upon illuminating smoke particles.

The present disclosure further provides a smoke detector including a light guiding and blocking member, a light source and a light sensor. The light guiding and blocking member includes a carrier wall, an accommodation space, a light trap region and a reflective tilted surface, wherein the reflective tilted surface is arranged above the light trap region, and the accommodation space is arranged between the carrier wall and the light trap region in a first direction. The light source is arranged on the carrier wall and configured to project a shaped light beam to the reflective tilted surface, wherein the reflective tilted wall is configured to reflect the shaped light beam to the light trap region. The light sensor is arranged inside the accommodation space and configured to receive scattered light generated by the shaped light beam upon illuminating smoke particles.

The present disclosure provides a light guiding and blocking member of a smoke detector including a light trap region, a reflective tilted surface, an accommodation space, a first light blocking wall and a second light blocking wall. The reflective tilted surface is arranged above the light trap region and configured to reflect light beams to the light trap region. The accommodation space is configured to accommodate a light sensor. The first light blocking wall is arranged at a side of the accommodation space farther away from the light trap region. The second light blocking wall is arranged at a side of the accommodation space closer to the light trap region, and between the light trap region and the accommodation space, wherein the second light blocking wall is higher than the first light blocking wall.

### BRIEF DESCRIPTION OF DRAWINGS

Other objects, advantages, and novel features of the present disclosure will become more apparent from the following detailed description when taken in conjunction with the accompanying drawings.

FIG. 1A is a cross sectional view of a smoke detector according to a first embodiment of the present disclosure.

FIG. 1B is a top view from a line A-A′ in the smoke detector of FIG. 1A.

FIG. 1C is a schematic diagram of a shaped light beam on a reflective tilted surface of a smoke detector according to one embodiment of the present disclosure.

FIG. 2A is a cross sectional view of a smoke detector according to a second embodiment of the present disclosure.

FIG. 2B is a top view from a line B-B′ in the smoke detector of FIG. 2A.

FIG. 3A is a cross sectional view of a smoke detector according to a third embodiment of the present disclosure.

FIG. 3B is a top view from a line C-C′ in the smoke detector of FIG. 3A.

FIG. 4A is a cross sectional view of a smoke detector according to a fourth embodiment of the present disclosure.

FIG. 4B is a top view from a line D-D′ in the smoke detector of FIG. 4A.

### DETAILED DESCRIPTION OF THE DISCLOSURE

It should be noted that, wherever possible, the same reference numbers will be used throughout the drawings to refer to the same or like parts.

One objective of the present disclosure is to provide a smoke detector that reduces the stray light interference caused by reflected light between inner surfaces of a detection space (or chamber) of the smoke detector. In the smoke detector, a diffractive optical element (DOE) is used to control an illumination range of an emission light beam of a light source, and a light trap region is further arranged to absorb stray light to accordingly increase a signal-to-noise ratio (SNR) of detected signals, which reflect light energy scattered by smoke particles 90. It should be mentioned that the component used to control the illumination range of the light source is not limited to DOE. For example, if a die of the light source (e.g., LED) is encapsulated by epoxy, the epoxy is arranged to control the illumination range of the light source to a desired range. That is, other components may be used to replace the DOE as long as the components have a function of controlling the illumination range of the light source.

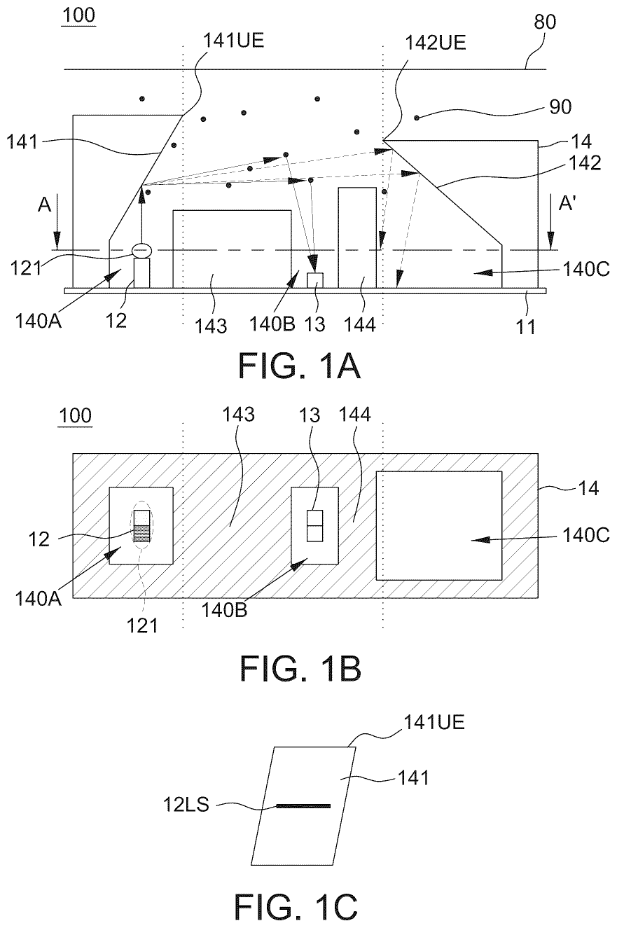

Please refer to FIGS. 1A to 1C, FIG. 1A is a cross sectional view of a smoke detector 100 according to a first embodiment of the present disclosure; FIG. 1B is a top view from a line A-A′ in the smoke detector 100 of FIG. 1A; and FIG. 1C is a schematic diagram of a shaped light beam 12LS on a first reflective tilted surface 141 of a smoke detector 100 according to one embodiment of the present disclosure.

An optical engine of the smoke detector 100 includes a substrate 11, a light source 12, a diffractive optical element (DOE) 121, a light sensor 13, and a light guiding and blocking member 14, wherein the light source 12, the light sensor 13 and the light guiding and blocking member 14 are arranged on the substrate 11. In one aspect, the light source 12 and the DOE 121 are previously formed as one module such that the position calibration is not required in assembling the smoke detector 100, but the present disclosure is not limited to.

The smoke detector 100 is formed with an inner space (or called chamber) therein by combining a base, on which the substrate 11 being attached, and a cover 80 via the sidewall(s), and the optical engine is arranged inside the inner space. The base is used to be attached on the position easily to detect smokes such as a ceiling or a wall. The optical engine of the smoke detector 100 of the present disclosure may be arranged on the base, the cover 80 or the sidewall(s) without particular limitations because light beams from the emission to the receiving do not propagate from one inner surface to another inner surface of the chamber.

In one aspect, when an emission angle of the light source 12 is controlled to be within a predetermined range (e.g., within an area of a first reflective tilted surface 141), the smoke detector 100 may be arranged without the DOE 121.

The substrate 11 is, for example, a printed circuit board or a flexible board, and electrically connected to the light source 12 and the light sensor 13.

The light guiding and blocking member 14 is made of plastic or rubber material. The light guiding and blocking member 14 is formed as an integrated structure by molding injection or formed as multiple separated parts that are arranged on the substrate 11 in assembling the smoke detector 100.

The light guiding and blocking member 14 includes a first accommodation space 140A, a second accommodation space 140B, a light trap region 140C, a first reflective tilted surface 141 and a second reflective tilted surface 142. The first reflective tilted surface 141 is arranged above the first accommodation space 140A, and the second reflective tilted surface 142 is arranged above the light trap region 140C. Preferably, the first reflective tilted surface 141 and the second reflective tilted surface 142 are polished to facilitate the light reflection. The second accommodation space 140B is arranged between the first accommodation space 140A and the light trap region 140C in a first direction (e.g., the left and right directions in FIGS. 1A and 1B).

The light guiding and blocking member 14 further includes a first light blocking wall 143 arranged at a side of the second accommodation space 140B farther from the light trap region 140C (i.e. between the first accommodation space 140A and the second accommodation space 140B) to prevent emission light from the light source 12 from directly propagating to the light sensor 13. That is, the first accommodation space 140A is arranged at a side of the first light blocking wall 143 farther from the second accommodation space 140B.

The light guiding and blocking member 14 further includes a second light blocking wall 144 arranged at a side of the second accommodation space 140B closer to the light trap region 140C (i.e. between the second accommodation space 140B and the light trap region 140C) to prevent stray light in the light trap region 140C from propagating to the light sensor 13. In one aspect, the second light blocking wall 144 is higher than the first light blocking wall 143, but not limited to.

In one aspect, an upper edge 141UE of the first reflective tilted surface 141 extends to be above the first light blocking wall 143 in the first direction (more specifically in a direction toward the light sensor 13), but the present disclosure is not limited thereto. In the aspect that the DOE 121 is used to limit an emission light beam of the light source 12, the upper edge 141UE of the first reflective tilted surface 141 is not necessary to be extended above the first light blocking wall 143 as long as the first reflective tilted wall 141 covers a range of the emission light beam of the light source 12.

In one aspect, an upper edge 142UE of the second reflective tilted surface 142 does not extend to be above the second light blocking wall 144 in the first direction (more specifically a direction toward the light sensor 13), but the present disclosure is not limited thereto. Depending on an angle that the first reflective tilted surface 141 reflects the emission light beam of the light source 12, the upper edge 142UE of the second reflective tilted surface 142 may extend to be above the second light blocking wall 144.

The light source 12 is, for example, a vertical cavity surface emitting laser (VCSEL), a light emitting diode or a laser diode. The light source 12 and the DOE 121 are arranged inside the first accommodation space 140A, and the light source 12 projects (e.g., upward) a shaped light beam via the DOE 121 to the first reflective tilted surface 141. In one aspect, the DOE 121 is used to shape the emission light beam of the light source 12 to a linear light beam 12LS (e.g., shown on the first reflective tilted surface 141 in FIG. 1C), an elliptic light beam or a circular light beam, but not limited thereto as long as the shaped light beam does not exceed an area of the first reflective tilted surface 141. A linear light beam 12LS is better than a dot light beam because an illuminating region is increased.

It should be mentioned that although FIG. 1A shows that the light source 12 emits light vertically (with respect to a surface of the substrate 11), the present disclosure is not limited to. In another aspect, the light source 12 emits the shaped light beam inclined to a side of the light source.

The first reflective tilted surface 141 is used to reflect the shaped light beam toward the second reflective tilted surface 142, and the second reflective tilted surface 142 is used to reflect the reflected and shaped light beam from the first reflective tilted surface 141 to the light trap region 140C. According to a tilted angle of the first reflective tilted surface 141, the first reflective tilted surface 141 reflects the shaped light beam horizontally, or with an elevation angle or a depression angle with respect to a surface of the substrate 11. Because the second reflective tilted surface 142 reflects the reflected and shaped light beam toward a bottom surface of the light trap region 140C, and the second reflective tilted surface 142 is right above the light trap region 140C, it is possible to reduce the amount of stray light escaping from the light trap region 140C and propagating to the light sensor 13.

The light sensor 13 is, for example, a complementary metal oxide semiconductor (CMOS) image sensor or a single photon avalanche diode (SPAD) image sensor. The light sensor 13 is arranged inside the second accommodation space 140B and used to receive scattered light generated when the reflected and shaped light beam illuminates smoke particles 90 in the chamber. It is appreciated that the distribution of the smoke particles 90 in the detection space (e.g., a space below the cover 80) of the smoke detector 100 is not limited to those shown in drawings of the present disclosure.

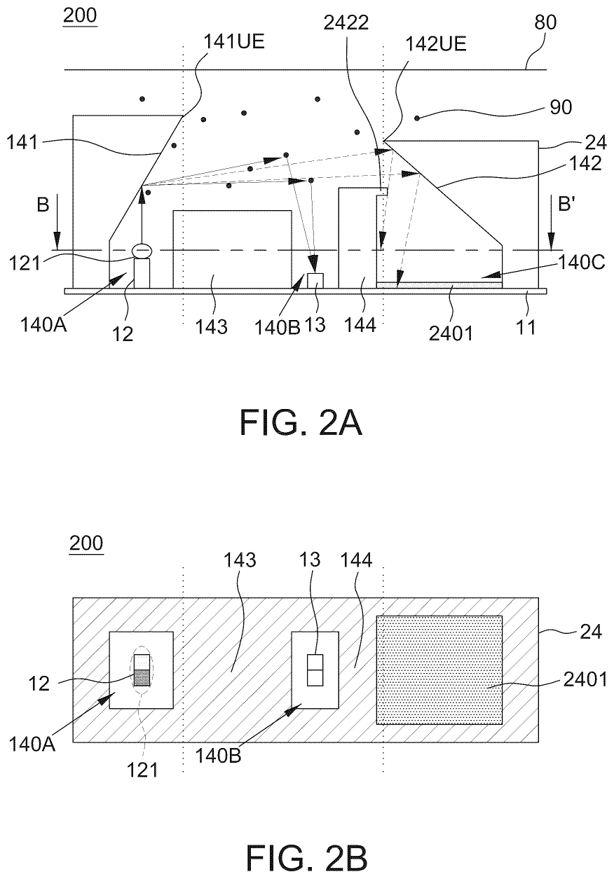

Please refer to FIGS. 2A and 2B, FIG. 2A is a cross sectional view of a smoke detector 200 according to a second embodiment of the present disclosure; and FIG. 2B is a top view from a line B-B′ in the smoke detector 200 of FIG. 2A. In FIGS. 2A and 2B, components identical to those in FIGS. 1A and 1B are indicated by the same reference numerals.

The difference between the smoke detector 200 of the second embodiment and the smoke detector 100 of the first embodiment is that a bottom surface of the light trap region 140C of the light guiding and blocking member 24 is further arranged with a light absorption member 2401 to absorb reflected light of the second reflective tilted surface 142. The light absorption member 2401 is, for example, a black cardboard, a black flannel, a black matte PVC board without particular limitations as long as the reflected light from the second reflective tilted surface 142 is absorbed thereby effectively. In addition, the second light blocking wall 144 of the smoke detector 200 further includes a protrusion part 2422 protruding out toward the second reflective tilted surface 412 vertically or tiltedly so as to reduce the mount of stray light in the light trap region 140C escaping out from the light trap region 140C. In addition to further arranging the light absorption member 2401 and/or the protrusion member 2422, other components of the smoke detector 200 are identical to those of the smoke detector 100 and thus details thereof are not repeated herein.

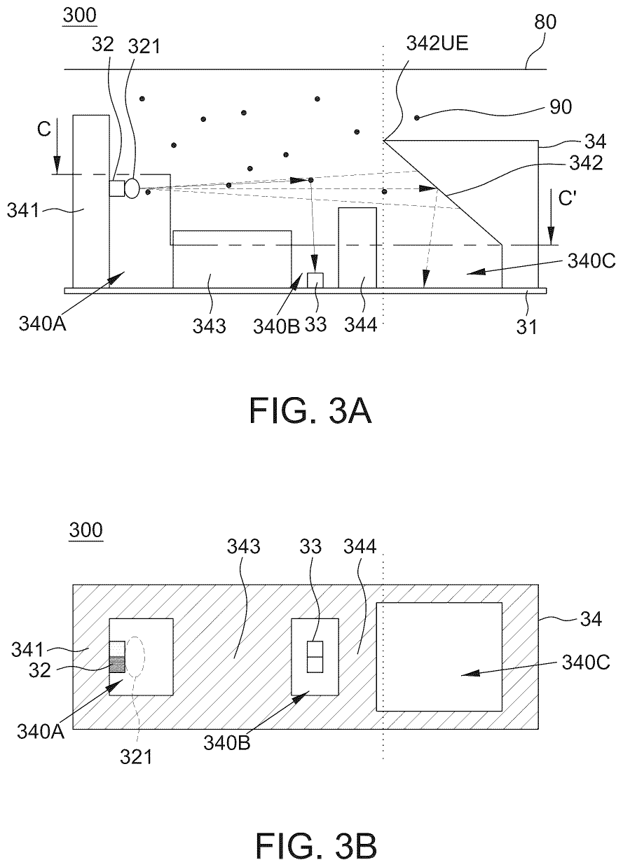

Please refer to FIGS. 3A and 3B, FIG. 3A is a cross sectional view of a smoke detector 300 according to a third embodiment of the present disclosure; FIG. 3B is a top view from a line C-C′ in the smoke detector 300 of FIG. 3A.

An optical engine of the smoke detector 300 includes a substrate 31, a light source 32, a diffractive optical element (DOE) 321, a light sensor 33 and a light guiding and blocking member 34, wherein the light sensor 33 and the light guiding and blocking member 34 are arranged on the substrate 31. In one aspect, the light source 32 and the DOE 321 are previously formed as one module such that the position calibration is not required in assembling the smoke detector 300, but not limited to.

The smoke detector 300 is also formed with an inner space therein by combining a base and a cover 80 via the sidewall(s), and the optical engine is arranged inside the inner space. The optical engine of the smoke detector 300 of the present disclosure is also arranged on the base, the cover 80 or the sidewall(s) without particular limitations.

In one aspect, when an emission angle of the light source 32 is controlled to be within a predetermined range (e.g., within an area of a reflective tilted surface 342), the smoke detector 300 may be configured without the DOE 321.

The substrate 31 is selected from a printed circuit board and a flexible board, and electrically connected to the light source 32 and the light sensor 33.

The light guiding and blocking member 34 is made of plastic or rubber material. The light guiding and blocking member 34 is formed as an integrated structure by molding injection or formed as multiple separated parts that are arranged on the substrate 31 in assembling the smoke detector 300.

The light guiding and blocking member 34 includes a first accommodation space 340A, a second accommodation space 340B, a light trap region 340C, a carrier wall 341 and a reflective tilted surface 342. The carrier wall 341 is arranged at a side (e.g., left side in FIGS. 3A and 3B) of the first accommodation space 340A, and the reflective tilted surface 342 is arranged above the light trap region 340C. The second accommodation space 340B is arranged between the first accommodation space 340A and the light trap region 340C in a first direction (e.g., the left and right directions in FIGS. 3A and 3B). The first accommodation space 340A is arranged between the carrier wall 341 and the second accommodation space 340B in the first direction.

The light guiding and blocking member 34 further includes a first light blocking wall 343 arranged at a side of the second accommodation space 340B farther from the light trap region 340C (i.e. between the carrier wall 341 and the second accommodation space 340B) to prevent emission light from the light source 32 from directly propagating to the light sensor 33. The first accommodation space 340A is arranged at a side of the first light blocking wall 343 farther from the second accommodation space 340B.

The light guiding and blocking member 34 further includes a second light blocking wall 344 arranged at a side of the second accommodation space 340B closer to the light trap region 340C (i.e. between the second accommodation space 340B and the light trap region 340C) to prevent stray light in the light trap region 340C from propagating to the light sensor 33. In one aspect, the second light blocking wall 344 is higher than the first light blocking wall 343, but not limited thereto.

In one aspect, an upper edge 342UE of the reflective tilted surface 342 does not extend to be above the second light blocking wall 344 in the first direction (more specifically a direction toward the light sensor 33), but the present disclosure is not limited thereto. Depending on an angle of the emission light beam of the light source 32, the upper edge 342UE of the reflective tilted surface 342 may extend to be above the second light blocking wall 344. Preferably, the reflective tilted surface 342 is polished to facilitate the light reflection.

The light source 32 is, for example, a VCSEL, a light emitting diode or a laser diode. The light source 32 and the DOE 321 are arranged on the carrier wall 341, and the light source 32 projects a shaped light beam via the DOE 321 to the reflective tilted surface 342, wherein the reflective tilted surface 342 is used to reflect the shaped light beam to the light trap region 340C. The light source 32 may project the shaped light beam horizontally, or with an elevation angle or a depression angle with respect to a surface of the substrate 31. In one aspect, the DOE 321 is used to shape the emission light beam of the light source 32 to a linear light beam (e.g., the 12LS shown in FIG. 1C), an elliptic light beam or a circular light beam, but not limited thereto as long as the shaped light beam does not exceed an area of the reflective tilted surface 342. Preferably, a length direction of the 12LS is parallel to the up and down directions of FIG. 3B. A height that the light source 32 being arranged on the carrier wall 341 is higher than heights of the first light blocking wall 343 and the second light blocking wall 344. The carrier wall 341 is arranged at a side of the first light blocking wall 343 farther from the second accommodation space 340B for carrying the light source 32, and a height of the carrier wall 341 is higher than the second light blocking wall 344.

Because the reflective tilted surface 342 reflects the shaped light beam toward a bottom surface of the light trap region 340C, and the reflective tilted surface 342 is right above the light trap region 340C, it is possible to reduce the amount of stray light escaping out from the light trap region 340C and propagating to the light sensor 33.

The light sensor 33 includes, for example, a CMOS image sensor or a SPAD image sensor. The light sensor 33 is arranged inside the second accommodation space 340B and used to receive scattered light generated when the shaped light beam illuminates smoke particles 90 in the chamber. It is appreciated that the distribution of the smoke particles 90 in the detection space (e.g., a space below the cover 80) of the smoke detector 300 is not limited to those shown in drawings of the present disclosure.

In one aspect, in order to allow the processor, e.g., a micro controller unit (MCU), an application specific integrated circuit (ASIC) or a field programmable gate array (FPGA), of the smoke detectors 100 to 400 of the present disclosure to be able to distinguish different smoke types, the light sources 12 and 32 are used to emit a first wavelength light (e.g., red light, but not limited to) and a second wavelength light (e.g., blue light, but not limited to), wherein a chip for emitting the first wavelength light and a chip for emitting the second wavelength light are different chips or the same chip, e.g., different light wavelengths are implemented by controlling driving parameters of the chips or arranging optical filters in front. The light sensors 13 and 33 have a first detection zone and a second detection zone for respectively detecting the first wavelength light and the second wavelength light. In one aspect, the first detection zone and the second detection zone are at the same pixel array but arranged with different optical filters in front to detect light of different wavelengths.

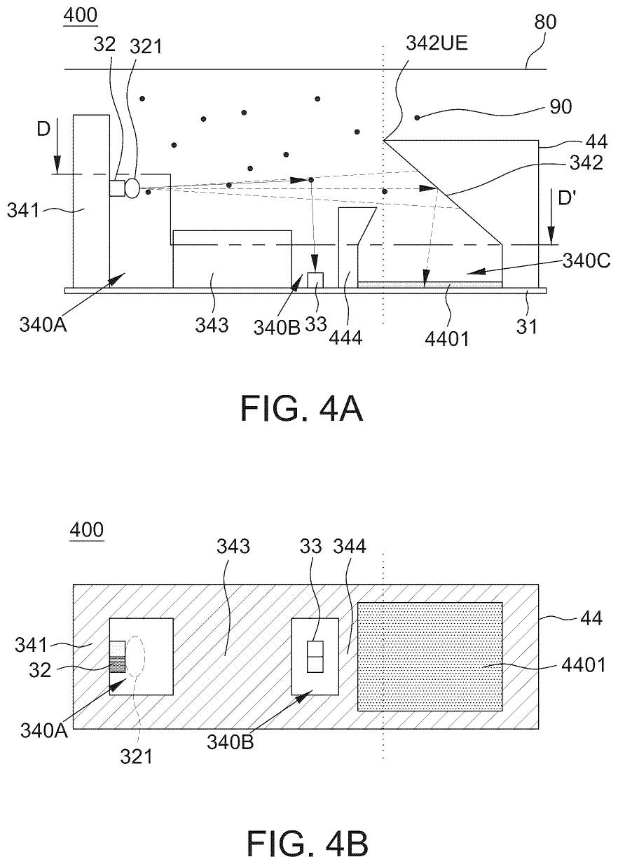

Please refer to FIGS. 4A and 4B, FIG. 4A is a cross sectional view of a smoke detector 400 according to a fourth embodiment of the present disclosure; and FIG. 4B is a top view from a line D-D′ in the smoke detector 400 of FIG. 4A. In FIGS. 4A and 4B, components identical to those in FIGS. 3A and 3B are indicated by the same reference numerals.

The difference between the smoke detector 400 of the fourth embodiment and the smoke detector 300 of the third embodiment is that a bottom surface of the light trap region 340C of the light guiding and blocking member 44 is further arranged with a light absorption member 4401 to absorb reflected light of the reflective tilted surface 342. The light absorption member4401 is, for example, also a black cardboard, a black flannel, a black matte PVC board without particular limitations. In addition, an upper part of the second light blocking wall 444 of the smoke detector 400 is arranged to protrude toward the second reflective tilted surface 412 tiltedly such that the upper part is wider than a lower part of the second light blocking wall 444 in the first direction so as to prevent stray light in the light trap region 340C from escaping out from the light trap region 340C. In addition to the light absorption member 4401 and/or a shape of the second light blocking wall 444, other components of the smoke detector 400 are identical to those of the smoke detector 300 and thus details thereof are not repeated herein.

In another aspect, the second light blocking wall 444 in FIG. 4B is arranged to have the protruding part 2422 as shown in FIG. 2A, or the second light blocking wall 144 in FIG. 2A is arranged to have a shape as the second light blocking wall 444 as shown in FIG. 4A. That is, the shapes of the second light blocking walls in FIGS. 2A and 4A are combinable.

It should be mentioned that although embodiments in FIGS. 3A-3B and FIGS. 4A-4B show that the light guiding and blocking members 34 and 44 still include a first accommodation space 340A, the present disclosure is not limited thereto. In another aspect, since the light source 32 and the DOE 321 are arranged on the carrier wall 341 without in the accommodation space 340A, the first light blocking wall 343 is directly connected to the carrier 341 without the first accommodation space 340A being formed.

It should be mentioned that although the drawings of the above embodiments show that the light absorption member is arranged only at a bottom surface of the light trap region, the present disclosure is not limited thereto. In another aspect, the light absorption member is further arranged on the vertical surface forming the light trap region to improve the light absorption efficiency.

It should be mentioned that although the light sources 12 and 32 in the above embodiments are described in the way to emit light of two wavelengths, the present disclosure is not limited thereto. The light sources 12 and 32 of the smoke detectors 100, 200, 300 and 400 may emit light more than two wavelengths in order to distinguish different smoke types. Details of distinguishing smoke types according to light intensity variation of multiple light sources may be referred to U.S. patent application Ser. No. 17/320,222, filed on May 14, 2021, assigned to the same assignee of the present application, and the full disclosure thereof is incorporated herein by reference.

As mentioned above, conventional optical smoke detectors have the issue of noises caused by stray light generated by light beams not being scattered by smoke particles that are continuously reflected in inner surfaces of a chamber of the optical smoke detectors. Accordingly, the present disclosure further provides a smoke detector that reduces the stray light interference (e.g., FIGS. 1A-4B), and a light guiding and blocking member thereof that adopt a diffractive optical element to control an emission light beam to be projected at a predetermined position, and adopt a light trap region to absorb light energy of light beams not scattered by smoke particles to prevent the stray light from propagating to a light sensor to form the noise interference thereby improving the SNR and reducing false alarm.

Although the disclosure has been explained in relation to its preferred embodiment, it is not used to limit the disclosure. It is to be understood that many other possible modifications and variations can be made by those skilled in the art without departing from the spirit and scope of the disclosure as hereinafter claimed.

1. A smoke detector, comprising:
a light guiding and blocking member, comprising a first accommodation space, a second accommodation space, a light trap region, a first reflective tilted surface and a second reflective tilted surface, wherein the first reflective tilted space is arranged above the first accommodation space, the second reflective tilted surface is arranged above the light trap region, and the second accommodation space is arranged between the first accommodation space and the light trap region in a first direction;
a light source, arranged inside the first accommodation space and configured to project a shaped light beam to the first reflective tilted surface, wherein the first reflective tilted surface is configured to reflect the shaped light beam toward the second reflective tilted surface, and the second reflective tilted surface is configured to reflect a reflected and shaped light beam from the first reflective tilted surface to the light trap region; and
a light sensor, arranged inside the second accommodation space and configured to receive scattered light generated by the reflected and shaped light beam upon illuminating smoke particles.

2. The smoke detector as claimed in claim 1, further comprising a substrate, wherein the light source, the light sensor and the light guiding and blocking member are arranged on the substrate.

3. The smoke detector as claimed in claim 1, further comprising a diffractive optical element configured to shape an emission light beam of the light source to a linear light beam, an elliptic light beam or a circular light beam as the shaped light beam.

4. The smoke detector as claimed in claim 1, wherein the light guiding and blocking member further comprises:
a first light blocking wall, arranged between the first accommodation space and the second accommodation space; and
a second light blocking wall, arranged between the second accommodation space and the light trap region,
wherein the second light blocking wall is higher than the first light blocking wall.

5. The smoke detector as claimed in claim 4, wherein an upper edge of the first reflective tilted surface extends to be above the first light blocking wall in the first direction.

6. The smoke detector as claimed in claim 4, wherein an upper edge of the second reflective tilted surface does not extend to be above the second light blocking wall in the first direction.

7. The smoke detector as claimed in claim 1, wherein a bottom surface of the light trap region is further arranged with a light absorption member to absorb reflected light of the second reflective tilted surface.

8. The smoke detector as claimed in claim 1, wherein
the light source is configured to emit a first wavelength light and a second wavelength light, and
the light sensor comprises a first detection zone and a second detection zone respectively configured to detect the first wavelength light and the second wavelength light.

9. A smoke detector, comprising:
a light guiding and blocking member, comprising a carrier wall, an accommodation space, a light trap region and a reflective tilted surface, wherein the reflective tilted surface is arranged above the light trap region, and the accommodation space is arranged between the carrier wall and the light trap region in a first direction;
a light source, arranged on the carrier wall and configured to project a shaped light beam to the reflective tilted surface, wherein the reflective tilted wall is configured to reflect the shaped light beam to the light trap region; and
a light sensor, arranged inside the accommodation space and configured to receive scattered light generated by the shaped light beam upon illuminating smoke particles.

10. The smoke detector as claimed in claim 9, further comprising a substrate, wherein the light sensor and the light guiding and blocking member are arranged on the substrate.

11. The smoke detector as claimed in claim 9, further comprising a diffractive optical element configured to shape an emission light beam of the light source to a linear light beam, an elliptic light beam or a circular light beam as the shaped light beam.

12. The smoke detector as claimed in claim 9, wherein the light guiding and blocking member further comprises:
a first light blocking wall, arranged between the carrier wall and the accommodation space; and
a second light blocking wall, arranged between the accommodation space and the light trap region,
wherein the second light blocking wall is higher than the first light blocking wall.

13. The smoke detector as claimed in claim 12, wherein an upper edge of the reflective tilted surface does not extend to be above the second light blocking wall in the first direction.

14. The smoke detector as claimed in claim 12, wherein a height of the light source arranged on the carrier wall is higher than heights of the first light blocking wall and the second light blocking wall.

15. The smoke detector as claimed in claim 9, wherein a bottom surface of the light trap region is further arranged with a light absorption member to absorb reflected light of the reflective tilted surface.

16. The smoke detector as claimed in claim 9, wherein
the light source is configured to emit a first wavelength light and a second wavelength light, and
the light sensor comprises a first detection zone and a second detection zone respectively configured to detect the first wavelength light and the second wavelength light.

17. A light guiding and blocking member of a smoke detector, the light guiding and blocking member comprising:
a light trap region;
a reflective tilted surface, arranged above the light trap region and configured to reflect light beams to the light trap region;
an accommodation space, configured to accommodate a light sensor;
a first light blocking wall, arranged at a side of the accommodation space farther away from the light trap region; and
a second light blocking wall, arranged at a side of the accommodation space closer to the light trap region, and between the light trap region and the accommodation space,
wherein the second light blocking wall is higher than the first light blocking wall.

18. The light guiding and blocking member as claimed in claim 17, further comprising:
another accommodation space, arranged at a side of the first light blocking wall farther away from the accommodation space and configured to accommodate a light source; and
another reflective tilted surface, arranged above said another accommodation space and configured to reflect an emission light beam of the light source to the reflective tilted surface.

19. The light guiding and blocking member as claimed in claim 17, further comprising:
a carrier wall, arranged at a side of the first light blocking wall farther away from the accommodation space and configured to carry a light source, wherein a height of the carrier wall is higher than that of the second light blocking wall.

20. The light guiding and blocking member as claimed in claim 17, wherein a bottom surface of the light trap region is further arranged with a light absorption member to absorb light beams reflected by the reflective tilted surface.
